(19) United States
(12) Patent Application Publication
(10) Pub. No.: US 2010/0090453 A1
(43) Pub. Date: Apr. 15, 2010

(54) TRAILER FOR CARRYING A WELDING UNIT FOR BUTT-WELDING PIPE PORTIONS

(76) Inventor: Renzo Bortoli, Torreglia (IT)

Correspondence Address: Modiano & Associati, Via Meravigli, 16, Milano, 20123, IT

(21) Appl. No.: 12/448,753

(22) PCT Filed: Jan. 25, 2008
(86) PCT No.: PCT/EP2008/050889

§ 371 Date: Jul. 6, 2009

(30) Foreign Application Priority Data
Jan. 29, 2007 (IT) PD2007A000023

(51) Int. Cl. B62D 63/06; B60K 1/00

(52) U.S. Cl. 280/789; 180/65.31; 219/67; 417/313

(57) ABSTRACT

Trailer for carrying a welding unit for butt-welding pipe portions, comprising a chassis with brackets for supporting and locking the body of a welding unit for butt-welding pipe portions, the chassis being provided with at least one pair of steered wheels, which can be oriented by means of a drawbar, and at least one pair of driving wheels, which are actuated by an electric motor, which in turn is powered by a current generator which is provided, together with the associated internal-combustion engine, on board the trailer; the chassis also supports a hydraulic pump and a hydraulic unit to which the hydraulic components of the body of the welding unit are to be connected, and an electrical unit for connecting the electrical devices with which the welding unit is provided; the chassis is provided with a fuel tank for the internal-combustion engine and an oil tank for the pump, the hydraulic unit and the hydraulic components of the welding unit connected to the pump; in this manner, the welding unit can be moved in the building yard fully autonomously.

The present invention relates to a trailer for carrying a welding unit for butt-welding pipe portions.

### BACKGROUND OF THE INVENTION

Welding units which use the technology of welding by polyfusion two facing end portions of two pipe segments made of plastic material are being used increasingly to weld ducts for pressurized fluids and in any case for pipes of substantial thickness.

These welding units are generally provided with a supporting chassis, on which four aligned clamps are mounted which lock in pairs the end portions of the pipes to be welded; two mutually opposite hydraulic pusher cylinders are associated with the clamps and allow to move such clamps so as to place in mutual contact the ends of the pipes to be welded.

The chassis with clamps, which forms the body of the welding unit, has associated therewith a milling machine, which can be extracted to flatten the ends of the pipe segments to be welded, a heating element, which likewise can be extracted in order to heat the ends, and an electrohydraulic unit, which in turn comprises an electric motor for driving a hydraulic pump, which sends the oil to a hydraulic unit to which the welding unit must be connected in order to close and move the clamps, while the electric motor powers all the electrical and electronic devices with which the welding unit is provided, including the heating element, and an optional control panel.

The body of the welding unit, due to its dimensions, is carried generally on a manually-towed trailer with a drawbar, which allows to move it in the building yard along the pipeline being built, while the electrohydraulic unit is mounted on a chassis which can be transported by hand or with other aid.

The electrohydraulic unit must then be connected to a power takeoff in order to supply power to the electric motor.

Manually-towed trailers of the known type, however, are often awkward to handle and maneuver, especially if the terrain over which the trailer must travel is uneven due to differences in level to be negotiated, such as for example slopes, humps or uneven rough ground, or if the terrain is soft, for example because it is muddy or sandy, these situations being not infrequent in a building yard.

This difficulty in maneuvering the trailer with a welding unit of the described type on board can be very dangerous, both for the safety of the operator who handles the trailer and for the welding unit, if control of the trailer is lost.

In order to obviate this drawback, machines for butt-welding pipe segments made of plastic material have been devised which are supported by a chassis provided with tracks; although this solution is functional and appreciated, it does not, however, allow the operator to follow precisely the movement path imposed by the path of the pipeline whose segments are to be provided, due to the typical maneuvering inaccuracies of a tracked vehicle during bends and in negotiating small humps.

Further, the tracked chassis is difficult to load onto the means of transport required to cover long distances (truck, pick-up, or other heavy vehicle), since its limited maneuvering precision can force several position adjustments before proceeding with the loading of the machine onto the means of transport.

### SUMMARY OF THE INVENTION

The aim of the present invention is to provide a trailer for carrying a welding unit for butt-welding pipe portions which is capable of obviating the drawbacks shown by known types of trailers and tracked machines.

Within this aim, an object of the present invention is to provide a trailer for carrying a welding unit for butt-welding pipe portions which is easy and handy to maneuver.

Another object of the present invention is to provide a trailer which can move more smoothly along more accurate paths than known types of tracked machine.

Another object of the present invention is to provide a trailer preset for carrying welding units for butt-welding pipe portions and in particular for welding units which use the technology of welding by polyfusion two facing end portions of two pipe segments made of plastic material.

Another object of the present invention is to provide a trailer which makes the welding unit autonomous, i.e., free to be moved independently of the electrical connection to a power takeoff of the building yard.

Another object of the present invention is to provide a trailer for carrying a welding unit for butt-welding pipe portions which can be manufactured cheaply with known systems and technologies.

This aim and these and other objects, which will become better apparent hereinafter, are achieved by a trailer for carrying a welding unit for butt-welding pipe portions, characterized in that it comprises a chassis with brackets for supporting and locking the body of a welding unit for butt-welding pipe portions, said chassis being provided with at least one pair of steered wheels, which can be oriented by means of a drawbar, and at least one pair of driving wheels, which are actuated by an electric motor, which in turn is powered by a current generator which is provided, together with the associated internal-combustion engine, on board the trailer, said chassis also supporting a hydraulic pump and a hydraulic unit to which the hydraulic components of the body of the welding unit are to be connected, and an electrical unit for connecting the electrical devices with which said welding unit is provided, said chassis being provided with a fuel tank for the internal-combustion engine and an oil tank for the pump, the hydraulic unit and the hydraulic components of the welding unit.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a front perspective view of a trailer according to the invention, with a welding unit for butt polyfusion installed thereon;

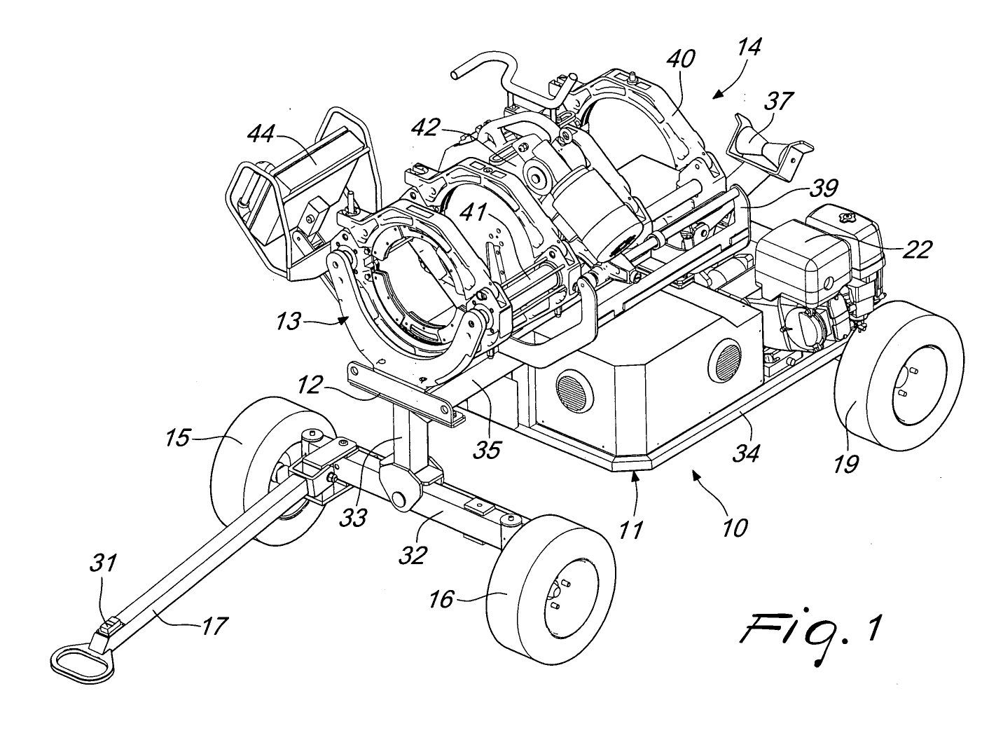

FIG. 2 is a rear perspective view of a trailer according to the invention;

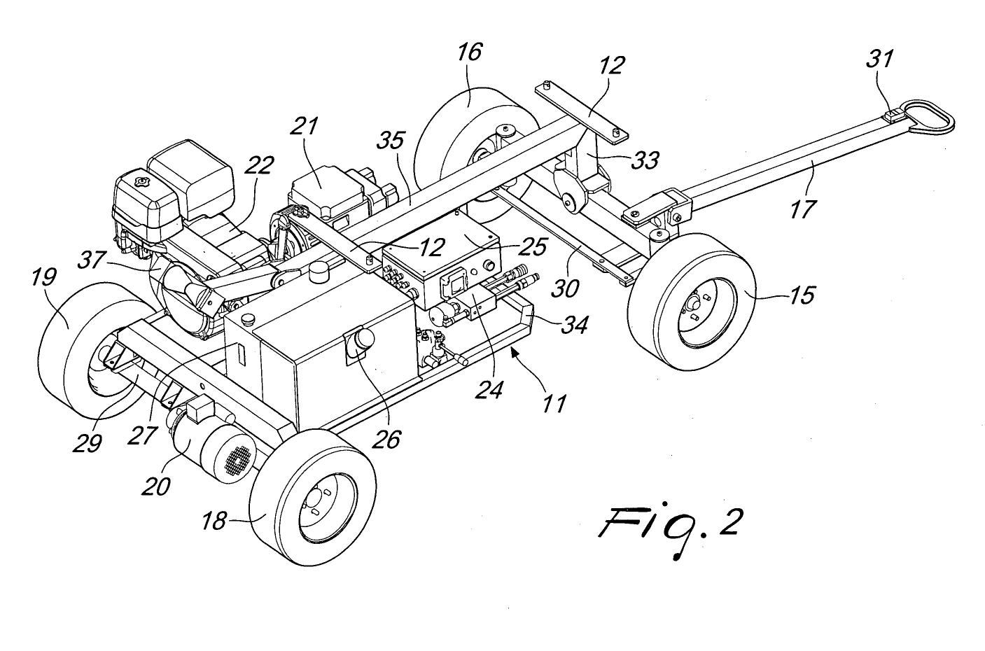

FIG. 3 is a front perspective view of a trailer according to the invention;

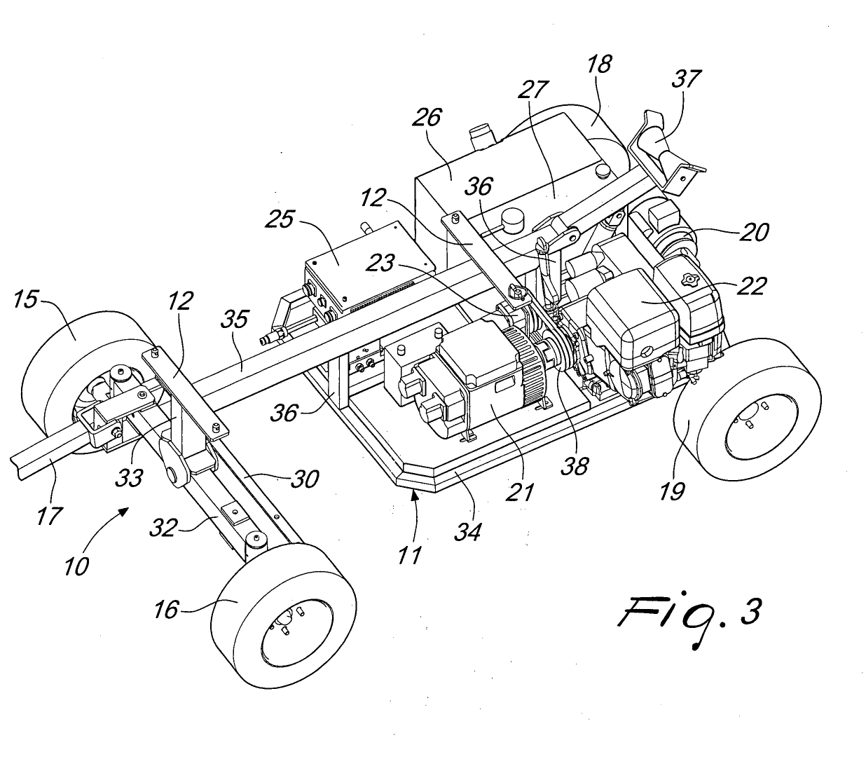

FIG. 4 is a rear perspective view of a trailer according to the invention, with the welding unit as in FIG. 1.

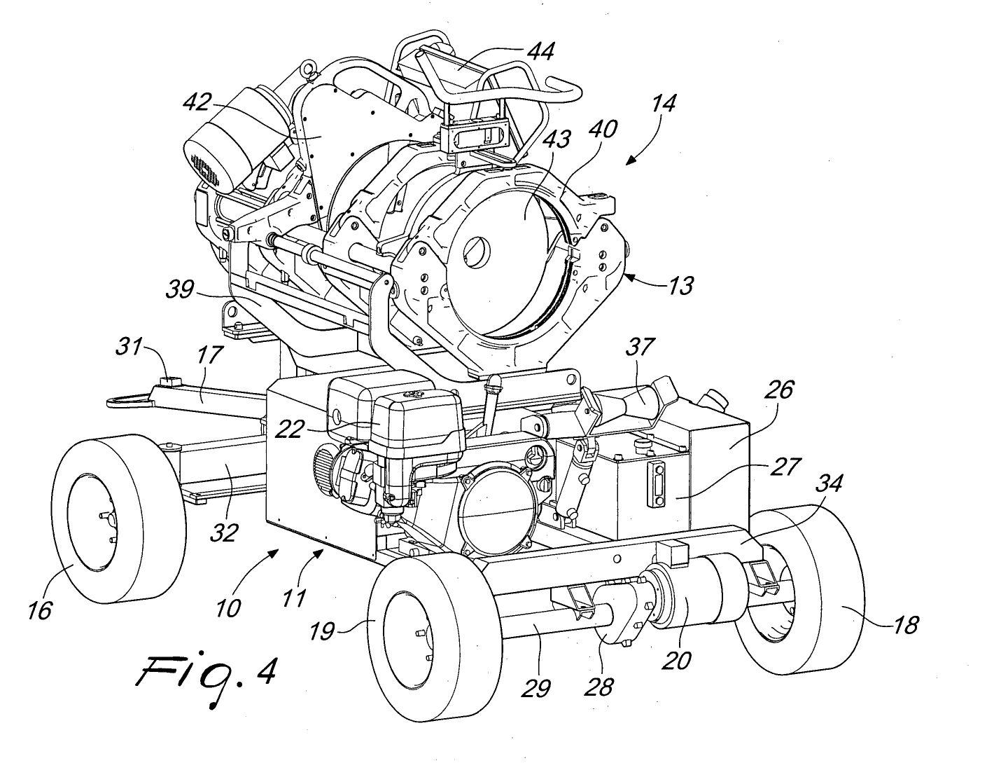

### DESCRIPTION OF THE PREFERRED EMBODIMENTS

With reference to the figures, a trailer for carrying a welding unit for butt-welding pipe portions according to the invention is generally designated by the reference numeral 10.

The trailer 10 comprises a chassis 11 with two brackets 12 for supporting and locking a body 13 of a welding unit 14 for butt-welding pipe portions.

The welding unit 14 shown here is, by way of example, of the type for butt polyfusion of portions of plastic pipe, but the trailer 10 according to the invention is to be understood as being adaptable also to other similar and equivalent welding units for butt-welding pipe portions.

The chassis 11 is provided with two front steered wheels 15 and 16, which can be oriented by means of a drawbar 17, and a pair of rear driving wheels 18 and 19.

The rear driving wheels 18 and 19 are actuated by an electric motor 20, which in turn is powered by a current generator 21 which is installed, with the associated internal-combustion engine 22, on board the trailer 10.

The driving wheels 18 and 19 are moved by the electric motor 20 by interposing a differential 28, which is associated with the rear axle 29.

The front steered wheels 15 and 16 can be oriented by means of an articulated quadrilateral 30, which can be turned by means of the drawbar 17, the drawbar 17 being provided with controls 31 for managing the electric motor 20; by means of these controls, it is possible to determine the forward or backward direction of motion of the trailer 10 and optionally adjust its travel speed.

The axle 32 of the front wheels 15 and 16 can oscillate, since it is pivoted to a front central upright 33 of the chassis 11.

The wheels 15, 16, 18 and 19 can be clawed for better grip for example on muddy terrain.

The chassis 11 also supports a hydraulic pump 23 and a hydraulic unit 24 to which the hydraulic components cited hereinafter of the body 13 of the welding unit 14 are to be connected, and an electrical unit 25 for connecting the electrical devices, also cited hereinafter, with which the welding unit 14 is equipped.

The pump 23 is preferably of the gear type and is driven by the internal-combustion engine 22 by means of a belt drive 38.

The chassis 11 further supports a fuel tank 26 for the internal-combustion engine 22 and an oil tank 27 for the pump 23, for the hydraulic unit 24 and for the hydraulic components of the welding unit that are served by the pump and by the hydraulic unit.

In the embodiment of the trailer 10 according to the invention described here by way of non-limiting example of the invention, the electric motor 20 is preferably of the single-phase asynchronous type, the current generator 21 is of the single-phase type, and the internal-combustion engine 22 is preferably a four-stroke gasoline-fueled engine.

The chassis 11 is composed of a base structure 34, for supporting the internal-combustion engine 22, the generator 21, the tanks 26 and 27, the pump 23, the hydraulic unit 24 and the electrical unit 25, and of a central longitudinal member 35, which rises from the base structure 34 with cross-members 36.

The central longitudinal member 35 supports the brackets 12 for supporting and locking the body 13 of the welding unit 14; the front end of the longitudinal member 35 supports the upright 33 to which the front axle 32 is pivoted, while the rear end of the longitudinal member 35 is provided with a pipe-laying roller unit 37.

The body 13 of the welding unit 14, described here by way of non-limiting example of the invention, comprises a supporting frame 39 on which four aligned clamps 40 are fitted which lock in pairs the end portions of the pipes to be welded by polyfusion; two mutually opposite hydraulic pusher cylinders 41 and clamping tension members for the jaws of the clamps 40; the cylinders are associated with the clamps 40 and allow the movement of said clamps so as to bring into mutual contact the ends of the pipes to be welded.

The welding unit 14 comprises, in addition to the body 13, a milling unit 42 which can be extracted to flatten the ends of the pipe segments to be welded, a heating element 43, which also can be extracted, for heating the ends, and an optional control panel 44.

The milling unit 42 and the heating element 43 are to be included among the electrical devices that belong to the welding unit 14, while the cylinders 41 for moving the clamps 40 belong to the hydraulic components of the welding unit 14.

In practice it has been found that the invention thus described solves the problems noted in manual trailers and in known tracked machines.

In particular, the present invention provides a trailer 10 for carrying a welding unit 14 for butt-welding pipe portions which is easy and handy to maneuver, by virtue of the driving wheels 18 and 19 moved by the electric motor 20; in this manner, an operator can move easily the welding unit 14 along a pipeline to be assembled without incurring any effort except for the effort related to maneuvering the drawbar 17; humps, uneven stretches and ground which is soft because it is muddy or sandy can be negotiated without effort by way of the action of the electric motor 20 and the aid of the differential 28, which optimizes the power distribution and the grip on the ground of the driving wheels 18 and 19.

Moreover, the present invention provides a trailer 10 which is capable of moving more smoothly along paths which are more precise than known types of tracked machine, indeed by virtue of the steered wheels on an oscillating axle, which allow maximum steering and maximum grip even in the most difficult situations.

Further, the present invention provides a trailer which is designed to carry welding units for butt-welding pipe portions and particularly but not exclusively for welding units which use the technology of welding by polyfusion two facing end portions of two pipe segments made of plastic material; said welding units are used particularly in building yards where gas or water pipelines, generally under pressure and having a large diameter are being laid.

Further, the present invention provides a trailer 10, which by carrying an electric generator and its associated combustion engine, hydraulic unit, electrical unit, hydraulic pump and tanks for gasoline and oil, makes the welding unit 14 autonomous, i.e., free to be moved independently of an electrical connection to a power takeoff of the yard or of a separate generator, a constraint which currently affects welding units for polyfusion butt welding.

Moreover, the present invention provides a trailer for carrying a welding unit for butt-welding pipe portions which can be manufactured cheaply with known systems and technologies.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2007A000023 from which this application claims priority are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

What is claimed is:

1-13. (canceled)

14. A trailer for carrying a welding unit for butt-welding pipe portions, comprising a chassis with brackets for supporting and locking the body of a welding unit for butt-welding pipe portions, said chassis being provided with at least one pair of steered front wheels, which can be oriented by means of a drawbar, and at least one pair of driving wheels, which are actuated by an electric motor, which in turn is powered by a current generator which is provided, together with an associated internal-combustion engine, on board the trailer, said chassis also supporting a hydraulic pump and a hydraulic unit to which hydraulic components of the body of the welding unit are to be connected, and an electrical unit for connecting electrical devices with which said welding unit is provided, said chassis being provided with a fuel tank for the internal-combustion engine and an oil tank for the pump, the hydraulic unit and the hydraulic components of the welding unit connected to the pump.

15. The trailer according to claim 14, comprising two rear driving wheels which are moved by said electric motor by virtue of the interposition of a differential, which is associated with a rear axle.

16. The trailer according to claim 14, wherein said front steered wheels can be oriented by means of an articulated quadrilateral which can be turned by means of said drawbar.

17. The trailer according to claim 14, wherein said drawbar is provided with controls for managing the electric motor, said controls allowing to determine forward or backward direction of motion of the trailer and optionally to adjust travel speed of the trailer.

18. The trailer according to claim 14, wherein an axle of the front wheels can oscillate, since it is pivoted to a front central upright of the chassis.

19. The trailer according to claim 14, wherein said electric motor is of a single-phase asynchronous type.

20. The trailer according to claim 14, wherein said current generator is of a single-phase type.

21. The trailer according to claim 14, wherein said internal-combustion engine is a four-stroke gasoline engine.

22. The trailer according to claim 18, wherein said chassis is composed of a base structure for supporting the internal-combustion engine, the generator, tanks, the pump, the hydraulic unit and the electrical unit, and a central longitudinal member, which is raised from the base structure with cross-members, said central longitudinal member supporting said brackets for supporting and locking the body of a said welding unit, a front end of said longitudinal member supporting the upright to which the front axle is pivoted, a rear end of the longitudinal member being provided with a pipe-laying roller unit.

23. The trailer according to claim 14, wherein said pump is of a gear type and is actuated by the internal-combustion engine by means of a belt drive.

24. The trailer according to claim 14, wherein said wheels can be clawed for better grip.

25. The trailer according to claim 14, wherein said body of the welding unit comprises a supporting frame on which four aligned clamps are fitted, said clamps locking in pairs end portions of pipes to be welded by polyfusion, two mutually opposite hydraulic pusher cylinders and clamping tension members for jaws of the clamps being associated with the clamps, said cylinders allowing movement of said clamps so as to bring into mutual contact the end portions of the pipes to be welded.

26. The trailer according to claim 25, wherein the body of the welding unit has associated therewith a milling unit which can be extracted to flatten the ends of the pipe segments to be welded, a heating element, which also can be extracted, in order to heat the ends, and an optional control panel.
